(19) United States
(12) Patent Application Publication
(10) Pub. No.: US 2002/0063439 A1
(43) Pub. Date: May 30, 2002

(54) Device for protecting a vehicle top surface

(76) Inventor: Laureat Bouchard, Ste-Julie (CA)

Correspondence Address: Laureat Bouchard, Condo #404, 70, boul. des Hauts-Bois, Ste-Julie, QC, J0L-2S0, CA

(21) Appl. No.: 09/985,503

(22) Filed: Nov. 5, 2001

(30) Foreign Application Priority Data
Nov. 28, 2000 (GB) 0028934.8

(51) Int. Cl. B60P 7/04

(52) U.S. Cl. 296/100.18

(57) ABSTRACT

A device for protecting a vehicle top surface and for removing snow from the vehicle top surface. The device includes a generally flexible membrane and a mounting mechanism allowing the membrane to slidably move between a covering configuration wherein the membrane covers the vehicle top surface and a retracted configuration wherein the membrane is removed from the vehicle top surface and is in an overlying relationship relative to the vehicle first side wall. The mounting mechanism allows the membrane to remain in a generally taut state as it is moved between the covering and retracted configurations, the membrane being bent according to a membrane bending angle that dislodges snow having adhered to the membrane. Optionally, the device further includes a binding snow breaking component mounted on the vehicle for locally breaking slabs of binding snow that may form between the membrane peripheral edges and adjacent structures part of the vehicle. The present invention also relates to a method for preventing from accumulating on the vehicle top surface. The method includes the step of mounting a membrane to the vehicle in a protecting configuration wherein the membrane generally protectively overlies the vehicle top surface so as to enable the membrane to collect a certain amount of the snow falling towards the vehicle top surface. Once a certain amount of snow has accumulated on the membrane, the membrane is moved from the protecting configuration to a retracted configuration wherein the membrane is at least partially retracted from the vehicle top surface and tilted at an angle allowing the discharge away from the vehicle of the snow having been collected by the membrane.

### FIELD OF THE INVENTION

The present invention relates to the general field of transportation vehicle accessories and is particularly concerned with a device for protecting a vehicle top surface.

### BACKGROUND OF THE INVENTION

The presence of snow or ice atop a vehicle or a large container such as a trailer or a semi-trailer, may lead to a potentially disastrous situation. Indeed, if a slab of snow or ice flies off the top of the vehicle and strikes a following vehicle the experience may be not only startling to the driver behind but the ice or snow may potentially also damage or break the windshield with consequent potential loss of control of the following vehicle.

Many localities now have laws requiring that snow or ice be removed from vehicles. With the increasing number of accidents, these official requirements have become more and more astringent.

The removal of snow and ice from trailers and semi-trailers has always been a concern of the trucking industry and, therefore, trucking companies spend considerable amount of money to clear snow and ice from the roof of trailers after every major snow storm. This effort not only takes money but also requires significant time so that the operation of the trucks of a large fleet can be delayed significantly after a snowstorm.

Furthermore, since the snow and ice removal is mostly performed manually by workers shovelling from the top of the trailers, potential danger also exists from such practice. Accordingly, there exists a need for an improved method and structure for removing snow and ice from atop tarpaulin-type transportation vehicle covers.

Advantages of the present invention include the fact that the proposed device for protecting a vehicle top surface is designed so as to selectively protect the top surface of vehicles such as trailers, semi-trailers or the like both of the open-top and closed-top type. The proposed method and device prevents the accumulation of snow or ice on the top surface of the vehicle. It also allows for removal of snow and ice from the top surface of the vehicles.

The proposed device is adapted to selectively extend a flexible membrane across the top surface of a vehicle so as to selectively protect the latter. Furthermore, the proposed device is particularly well suited to allow removal of ice and/or snow slabs from atop vehicles through a set of quick and ergonomic steps without requiring manual dexterity or special tooling and without requiring that an individual climb on top of the vehicle.

The proposed device facilitates drawing the flexible membrane into proper covering or retracted positions while maintaining, through the use of specifically designed mechanisms, the flexible membrane in a relatively taut condition throughout the movement thereof between positions. Also, during movement between the covering and retracted positions the membrane is bent at an angle adapted to facilitate the removal of snow or ice that may have adhered to the membrane.

Furthermore, the device is provided with a component for removing snow or ice that may have adhered to both the membrane and the vehicle so as to facilitate movement of the membrane. Also, the proposed device facilitates securing the flexible membrane to the vehicle. The securing components are specifically designed so as to be aerodynamic.

The device may also be used for selectively covering open-top vehicles such as open-top trailers, semi-trailers or the like.

In accordance with an embodiment of the present invention, there is provided a device for protecting a vehicle top surface part of a vehicle and for removing snow from the vehicle top surface, the vehicle top surface defining a top surface first side peripheral edge, an opposed top surface second side peripheral edge, a top surface first end peripheral edge and an opposed top surface second end peripheral edge, the vehicle defining a vehicle first side wall extending from the top surface first side peripheral edge and a vehicle second side wall extending from the top surface second side peripheral edge, the vehicle also defining a vehicle first end wall extending from the top surface first end peripheral edge and a vehicle second end wall extending from the top surface second end peripheral edge, the vehicle further defining a vehicle bottom wall, the device comprising: a generally flexible membrane, the membrane being configured and sized so as to substantially cover the vehicle top surface when the membrane is in a covering configuration substantially overlying the vehicle top surface; a mounting means attached to both the vehicle and the membrane for mounting the membrane to the vehicle, the mounting means allowing the membrane to slidably move between the covering configuration and a retracted configuration wherein the membrane is at least partially removed from the vehicle top surface and the membrane is at least partially in an overlying relationship relative to the vehicle first side wall.

Preferably, the membrane is mounted on the vehicle by the mounting means so as to be in a substantially taut state when in both the covering and retracted configurations. Conveniently, the membrane is mounted on the vehicle so as to remain in a generally taut state as it is moved between the covering and retracted configurations, the membrane being bent according to a membrane bending angle as it moves between the covering and retracted configurations. Conveniently, the device further comprises a moving means for moving the membrane between the covering and retracted configurations.

Preferably, the membrane defines a membrane first side peripheral edge, a membrane second side peripheral edge, a membrane first end peripheral edge and a membrane second end peripheral edge; the moving means including a moving cable, the moving cable defining a cable first end and a cable second end, the cable first end being attached to the membrane first side peripheral edge and the cable second end being attached to the membrane second side peripheral edge; a winding device mounted on the vehicle for winding the moving cable so that selective winding and unwinding of the moving cable on and from the winding device allows for the movement of the membrane between the covering and retracted configurations.

Conveniently, the moving means includes a cable guiding means mounted on the vehicle for guiding the slidable movement of the moving cable relative to the vehicle. Preferably, the moving means includes a friction reducing means mounted on the vehicle for reducing the frictional force created by the slidable movement of the moving membrane relative to the vehicle when the moving membrane is moved between the covering and retracted configurations.

Conveniently, the moving means includes a range limiting means mounted on the vehicle for limiting the range of movement of the moving membrane relative to the vehicle. Preferably, the moving means includes a cable tightening means mounted on the vehicle for maintaining the moving cable in a generally tightened state.

Conveniently, the device further comprises a binding snow breaking means mounted on the vehicle for locally breaking slabs of binding snow that may form between the membrane first and second end peripheral edges and adjacent structures part of the vehicle binding the membrane first and second end peripheral edges and adjacent structures part of the vehicle together and preventing the movement of the moving membrane. Preferably, the binding snow breaking means has a generally aerodynamical configuration.

In accordance with the present invention, there is also provided a method for preventing snow falling towards a vehicle top surface part of a vehicle from accumulating on the vehicle top surface, the vehicle top surface defining pair of top surface side peripheral edges, the vehicle defining a pair of vehicle side walls extending from the vehicle top surface, the method comprising the steps of: mounting a membrane to the vehicle in a protecting configuration wherein the membrane generally protectively overlies the vehicle top surface so as to enable the membrane to collect a certain amount of the snow falling towards the vehicle top surface; once a certain amount of snow has accumulated on the membrane, moving the membrane while the latter is still mounted on the vehicle from a protecting configuration to a retracted configuration wherein the membrane is at least partially retracted from the vehicle top surface and tilted at an angle allowing the discharge away from the vehicle of the certain amount of the snow having been collected by the membrane when the latter was in the protecting configuration.

Preferably, the membrane lies in a generally parallel relationship relative to one of the vehicle sidewalls when the membrane is in the retracted configuration.

Conveniently, the method further comprises the steps of maintaining the membrane in a generally taut state when in both the covering and retracted configurations.

Preferably, the membrane slidably contacts one of the top surface second side peripheral edges as it moves between the protecting and retracted configurations, the contact with one of the top surface second side peripheral edges allowing the membrane to be bent at a membrane angle allowing for the dislodgment from the membrane of snow accumulation that may have adhered to the membrane.

In accordance with the present invention, there is further provided a device for protecting a vehicle top surface part of a vehicle and for removing snow from the vehicle top surface, the vehicle top surface defining a top surface first side peripheral edge, an opposed top surface second side peripheral edge, a top surface first end peripheral edge and an opposed top surface second end peripheral edge, the vehicle defining a vehicle first side wall extending from the top surface first side peripheral edge and a vehicle second side wall extending from the top surface second side peripheral edge, the vehicle also defining a vehicle first end wall extending from the top surface first end peripheral edge and a vehicle second end wall extending from the top surface second end peripheral edge, the vehicle further defining a vehicle bottom wall, the device comprising: a generally flexible membrane, the membrane being configured and sized so as to substantially cover the vehicle top surface when the membrane is in a covering configuration substantially overlying the vehicle top surface; a mounting mechanism attached to both the vehicle and the membrane for mounting the membrane to the vehicle, the mounting mechanism allowing the membrane to slidably move between the covering configuration and a retracted configuration wherein the membrane is at least partially removed from the vehicle top surface and the membrane is at least partially in an overlying relationship relative to the vehicle first side wall; the mounting mechanism allowing the membrane to be in a substantially taut state when in both the covering and retracted configurations and to remain in a generally taut state as it is moved between the covering and retracted configurations.

Preferably, the mounting mechanism allows the membrane to slidably contacts one of the top surface second side peripheral edges as it moves between the protecting and retracted configurations, the contact with one of the top surface second side peripheral edges allowing the membrane to be bent at a membrane angle allowing for the dislodgment from the membrane of snow accumulation that may have adhered to the membrane.

Conveniently, the device further comprises a moving mechanism for moving the membrane between the covering and retracted configurations; the membrane defining a membrane first side peripheral edge, a membrane second side peripheral edge, a membrane first end peripheral edge and a membrane second end peripheral edge;

the moving mechanism including a moving cable, the moving cable defining a cable first end and a cable second end, the cable first end being attached to the membrane first side peripheral edge and the cable second end being attached to the membrane second side peripheral edge; the moving mechanism also including a winding device mounted on the vehicle for winding the moving cable so that selective winding and unwinding of the moving cable on and from the winding device allows for the movement of the membrane between the covering and retracted configurations.

Preferably, the moving mechanism includes a cable tightening mechanism mounted on the vehicle for maintaining the moving cable in a generally tightened state. Conveniently, the device further comprises a binding snow breaking mechanism mounted on the vehicle for locally breaking slabs of binding snow that may form between the membrane first and second end peripheral edges and adjacent structures part of the vehicle binding the membrane first and second end peripheral edges and adjacent structures part of the vehicle together and preventing the movement of the moving membrane.

### BRIEF DESCRIPTION OF THE DRAWINGS

An embodiment of the present invention will now be disclosed, by way of example, in reference to the following drawings in which:

FIG. 1: in a partial perspective view with sections taken out, illustrates a device for protecting a vehicle top surface in accordance with a first embodiment of the present invention being mounted on the top surface of a truck trailer, the truck and associated trailer being shown in phantom lines.

FIG. 2: in a schematic front view illustrates a device in accordance with the embodiment shown in FIG. 1 mounted on a truck trailer, the truck trailer being shown in phantom lines, the device being shown in a protecting configuration.

FIG. 3: in a schematic front view illustrates a device in accordance with the embodiment shown in FIG. 1 mounted on a truck trailer, the truck trailer being shown in phantom lines, the device being shown in a retracted configuration.

FIG. 4: in a partial perspective view with sections taken out, illustrates some of the component of a moving mechanism part of the device shown in FIG. 1 through FIG. 3 mounted on a conventional truck trailer.

FIG. 5: in a partial transversal cross-sectional view illustrates the contact between a lateral peripheral edge of a trailer and a membrane part of the device shown in FIG. 1 through FIG. 4.

FIG. 6: in a partial perspective with sections taken out, illustrates a friction-reducing component part of a device in accordance with the present invention being mounted on the lateral peripheral edge of the conventional trailer.

FIG. 7: in a partial perspective view with sections taken out, illustrates a cable guiding channel part of a device in accordance with an embodiment of the present invention.

FIG. 8: in a partial perspective view with sections taken out, illustrates a cable-to-membrane attachment component part of a device in accordance with an embodiment of the present invention.

FIG. 9: in a partial perspective view illustrates part of a membrane supporting component being used with a device in accordance with an embodiment of the present invention.

FIG. 10: in a partial elevational view with some sections taken out, illustrates part of a binding snow breaking mechanism in accordance with a first embodiment of the present invention, the binding snow breaking mechanism being shown in a deflated configuration with a slab of snow resting thereon.

FIG. 11: in a partial elevational view with some sections taken out, illustrates part of a binding snow breaking mechanism in accordance with a first embodiment of the present invention, the binding snow breaking mechanism being shown in an inflated configuration with a slab of snow being detached therefrom.

FIG. 12: in a partial side elevational view with sections taken out, illustrates part of a cable winding mechanism associated with a device in accordance with a first embodiment of the present invention.

FIG. 13: in a partial transversal cross-sectional view taken along arrows 13 of FIG. 12 illustrates some of the components of the cable winding mechanism shown in FIG. 12.

FIG. 14: in a partial perspective view with sections taken out, illustrates some of the components of the winding mechanism shown in FIGS. 12 and 13.

FIG. 15: in a partial perspective with sections taken out, illustrates a device for protecting a vehicle top surface in accordance with a second embodiment of the present invention.

FIG. 16: in a schematic front elevational view with sections taken out, illustrates the device shown in FIG. 15 mounted on a conventional container shown in phantom lines and being in a covering configuration.

FIG. 17: in a schematic front elevational view with sections taken out, illustrates the device shown in FIG. 15 mounted on a conventional container shown in phantom lines and being in a retracted configuration.

FIG. 18: in a partial perspective view with sections taken out, illustrates the relationship between a lateral section of a membrane part of the present invention and the peripheral edge of a conventional container.

FIG. 19: in a partial cross-sectional with sections taken out, illustrates part of a binding snow breaking mechanism in accordance with a second embodiment of the present invention, the binding snow breaking mechanism being shown in its deflated configuration in full lines and its inflated configuration in phantom lines.

FIG. 20: in a partial perspective view with sections taken out, illustrates some of the components of the binding snow breaking mechanism shown in FIG. 19.

FIG. 21: in a partial transversal cross-sectional view with sections taken out, illustrates a pulley component mounted to a conventional truck trailer, the pulley component being part of a moving mechanism associated with the device in accordance with a second embodiment of the present invention.

FIG. 22: in a perspective view illustrates in greater details the pulley component shown in FIG. 21.

FIG. 23: in a partial perspective view with sections taken out, illustrates parts of a cable guiding component associated with the device in accordance with the second embodiment of the present invention.

FIG. 24: in a partial elevational view with sections taken out, illustrates the pulley component shown in FIGS. 21 and 22 attached to a section of a conventional trailer.

FIG. 25: in a partial elevational view with sections taken out, illustrates a cable redirecting mechanism associated with the device in accordance with the second embodiment of the present invention.

FIG. 26: in a partial transversal cross-sectional view taken along arrows 26 of FIG. 25 illustrates some of the components of the cable redirecting mechanism shown in FIG. 25.

FIG. 27: in a partial bottom with sections taken out, illustrates a cable tensioning mechanism in accordance with a second embodiment of the present invention being mounted to the inner surface of the roof of a conventional truck trailer.

FIG. 28: in an exploded view illustrates some of the components of the cable tensioning mechanism shown in FIG. 27.

FIG. 29: in a partial perspective view with sections taken out, illustrates a cable winding mechanism in accordance with a second embodiment of the present invention.

FIG. 30: in a partial longitudinal cross-sectional view illustrates some of the components associated with a range limiting mechanism part of the device in accordance with a second embodiment of the present invention.

### DETAILED DESCRIPTION OF THE INVENTION

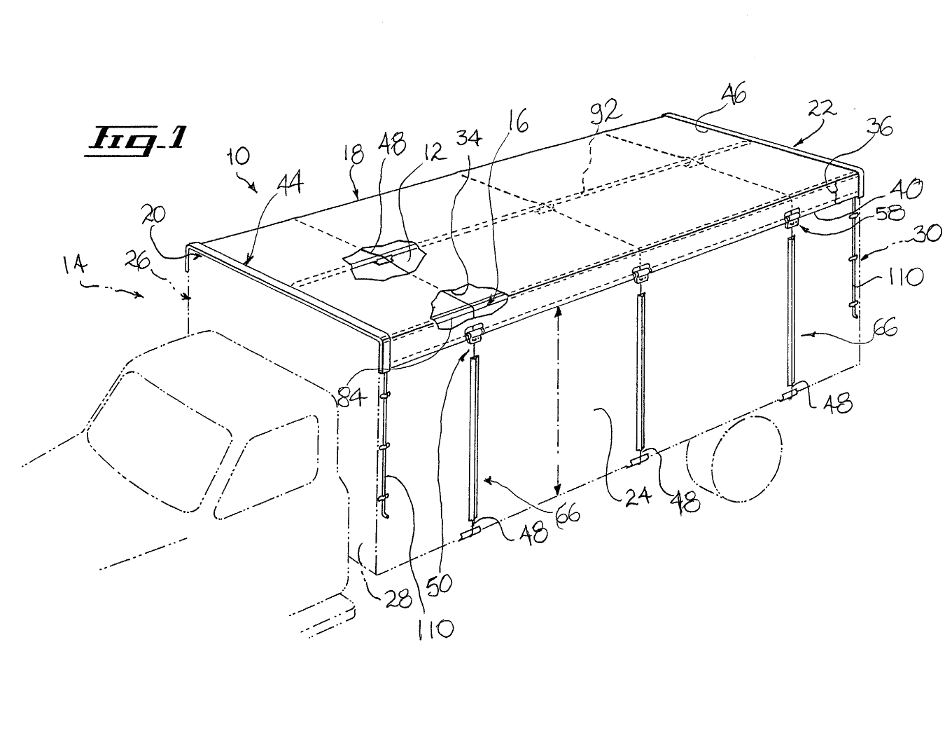

Referring to FIG. 1, there is shown a device 10 for protecting a vehicle top surface in accordance with a first embodiment of the present invention. The device 10 is shown mounted over a top surface 12 part of a truck trailer 14. It should be understood that the device 10 could be used for protecting the top surface of other types of vehicles such as semi trailers, open top containers or the like without departing from the scope of the present invention. The device 10 could also be used for protecting the top surface of other objects such as containers, storage bins or the like without departing from the scope of the present invention.

In FIG. 1, the device 10 is thus shown covering the top surface 12 of a conventional truck trailer 14. The top surface 12, in turn, defines a top surface first side peripheral edge 16 and an opposed top surface second peripheral edge 18. The top surface 12 also defines a top surface first end peripheral edge 20 and an opposed top surface second end peripheral edge 22.

The vehicle 14 defines a vehicle first side wall 24 extending from the top surface first side peripheral edge 16 and a vehicle second side wall 26 extending from the top surface second side peripheral edge 18. The vehicle 12 further defines a vehicle first end wall 28 extending from the top surface first end peripheral edge 20 and a vehicle second end wall 30 extending from the top surface second end peripheral edge 22. As shown more specifically in FIGS. 2 and 3, the vehicle 12 further defines a vehicle bottom wall 32.

Although the device 10 is shown mounted over a closed top vehicle 14, it should be understood the device 10 could be used with open top vehicle or containers with small modifications thereto and without departing from the scope of the present invention.

The device 10 includes a generally flexible and preferably wear-resistance membrane 34. The membrane 34 is configured and sized so as to substantially cover the vehicle top surface 12 when the membrane 34 is in a covering configuration shown in FIGS. 1 and 2 substantially overlying the vehicle top surface 12. The membrane 34 typically has a generally rectangular configuration and is preferably sized so that its longitudinal ends may be substantially in register and aligned relative to the top surface first and second end peripheral edges 20, 22. The membrane 34 is also preferably sized so that its longitudinal peripheral edges extend beyond the top surface first and second side peripheral edges 16, 18 thus defining a pair of side overlapping sections 36 that overlap an upper portion of the vehicle first and second side walls of 24, 26.

Typically, the overlapping section 36 extends over a distance having a value substantially in the range of 6 inches. It should be understood that the dimension of the overlapping section 36 could vary without departing from the scope of the present invention. The membrane 34 is typically made out of fibreglass, canvas, a polymeric resin or any other suitable material.

The device 10 also includes a mounting means attached to both the vehicle 14 and the membrane 34 for mounting the membrane 34 to the vehicle 14. The mounting means allows the membrane 34 to slideably move between the covering configuration shown in FIGS. 1 and 2 and a retracted configuration shown in FIG. 3 wherein the membrane 34 is at least partially removed from the vehicle top surface 12 and the membrane 34 is in a at least partially overlying relationship relative to the vehicle first side wall 24. In FIG. 3, the membrane 34 is shown totally retracted from the vehicle top surface 12 and a fully overlying relationship relative to the vehicle first side wall 24. in the embodiment shown in FIGS. 1 through 14, the membrane 34 could be slideably moved to either one of the vehicle side surfaces 24 or 26.

The membrane 34 defines a membrane first side peripheral edge 40, an opposed membrane second side peripheral edge 42, a membrane first end peripheral edge 44 and an opposed membrane second end peripheral edge 46.

The membrane 34 is mounted on the vehicle 14 by the mounting means so as to be in a substantially taut state when in both the covering and retracted configurations. Preferably, the membrane 34 is mounted on the vehicle 14 so as to remains in generally taut state as it is moved between the covering and retracted configurations respectively shown in FIGS. 2 and 3.

The membrane 34 thus preferably bends according to a membrane bending angle as it moves between the covering and the retracted configurations. The membrane bending angle is typically defined by the angle 38 shown in FIG. 2 between the vehicle top surface 12 and one of the vehicle side surfaces 24, 26. Bending of the membrane 34 as it moved between the covering and retracted configuration allows for snow that may have adhered to the top surface of the membrane 34 to be dislodged from the latter.

The device 10 further includes a moving means for moving the membrane 34 between the covering and retracted configurations. The moving means typically include at least one and preferably a set of moving cables 48. In the various figures, the device 10 is shown as using three moving cables 48 although it should be understood that the device 10 could use any number of moving cables 48 without departing from the scope of the invention. Each moving cable 48 defines a cable first attachment section 50 and cable second attachment section 52 respectively attached to the membrane first and second side peripheral edges by cable-to-membrane means.

The moving means also includes a winding device mounted on the vehicle 14 for winding the moving cables 48 so that selective winding and unwinding of the moving cables 48 on and from the winding device allows for the movement of the membrane 34 between the covering and retracted configuration.

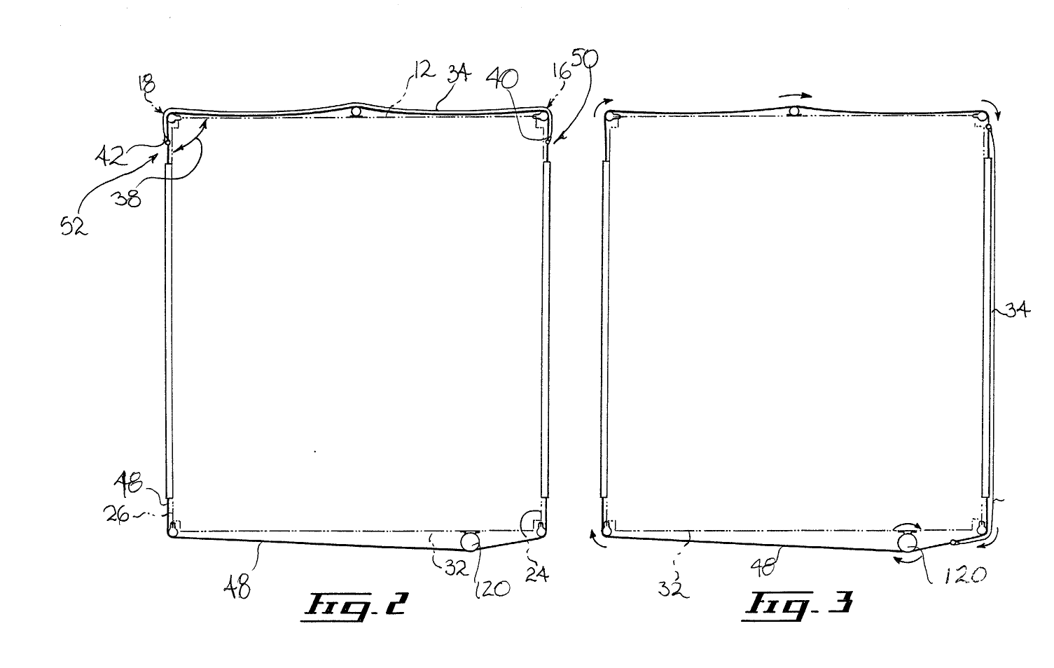

As illustrated in greater details in FIGS. 4, 5 and 8, the cable-to-membrane attachment means typically includes a pair of attachment rods 54 secured to the membrane first and second side peripheral edges 40, 42. Typically, the attachment rods 54 are secured to the membrane first and second side peripheral edges 40, 42 by having a segment of the membrane side peripheral edges 40, 42 folded over a corresponding attachment rod 54 and sown or otherwise attached so as to define a rod sleeve 56.

The cable-to-membrane attachment means typically also includes a cable-to-rod attachment component 58 for securing each cable 48 to the attachment rods 54.

As shown in greater detail in FIG. 8, each cable-to-rod attachment component 58 preferably includes a sleeve section 60 configured in size for substantially fittingly receiving an attachment rod 54. Each cable-to-rod attachment component 58 also includes a cable attachment plate 62 extending outwardly and radially from the sleeve section 60.

The cable attachment plate 62 is provided with a set of cable anchoring apertures 64 extending there through. The cable anchoring apertures 64 are configured in size for slideably receiving a segment of a cable 48 so that the latter may be wrapped through adjacent apertures 64 thus frictionally securing the cable 48 to the cable-to-rod attachment component 58 while allowing for easy length adjustment and tightening of cable 48 through set of easy and ergonomical steps.

As illustrated more specifically in FIGS. 5 and 7, the moving means preferably include a cable guiding means mounted on the vehicle 14 for guiding the slideable movements of the moving cables 48 relative to the vehicle 14. The cable guiding means typically includes a set of guiding components 66 mounted on the vehicle first and second side walls 24, 26 substantially and registered with the cables 48.

As shown more specifically in FIG. 7, each guiding component 66 typically includes a guiding component base 68 provided base apertures 70 extending therethrough for receiving base fixing components 72 such as rivets, bolts, screws or the like adapted to attach the guiding component base 68 to one of the first or second vehicle side walls 24, 26. Each guiding component 66 is typically further provided with a pair of guiding arms 74 extending substantially perpendicularly from the guiding component base 68 in a predetermined space relationship relative to each other so as to define a guiding channel 76 there between. The guiding channel 76 is configured and sized for slideably receiving a segment of the cable 48.

As illustrated more specifically in FIGS. 2 through 6, the moving means is preferably further provided with a friction reducing means mounted on the vehicle 14 for reducing the frictional force created by the slideable movement of the moving membrane 34 relative to the vehicle 14 as the moving membranes move between the covering and the retracted configurations.

The frictional reducing means typically includes a set of generally elongated friction-reducing components 78 adapted to be secured to the vehicle 14 preferably adjacent the top surface first and second side peripheral edges 16, 18 and adjacent the intersection between the bottom surface 32 and the vehicle first and second side surfaces 24, 26. The vehicle first and second side peripheral edges 16, 18 and the intersection between vehicle bottom wall 32 and vehicle first and second side wall 24, 26 are all preferably provided with a mounting recess 80 defining a longitudinally extending mounting lip 82.

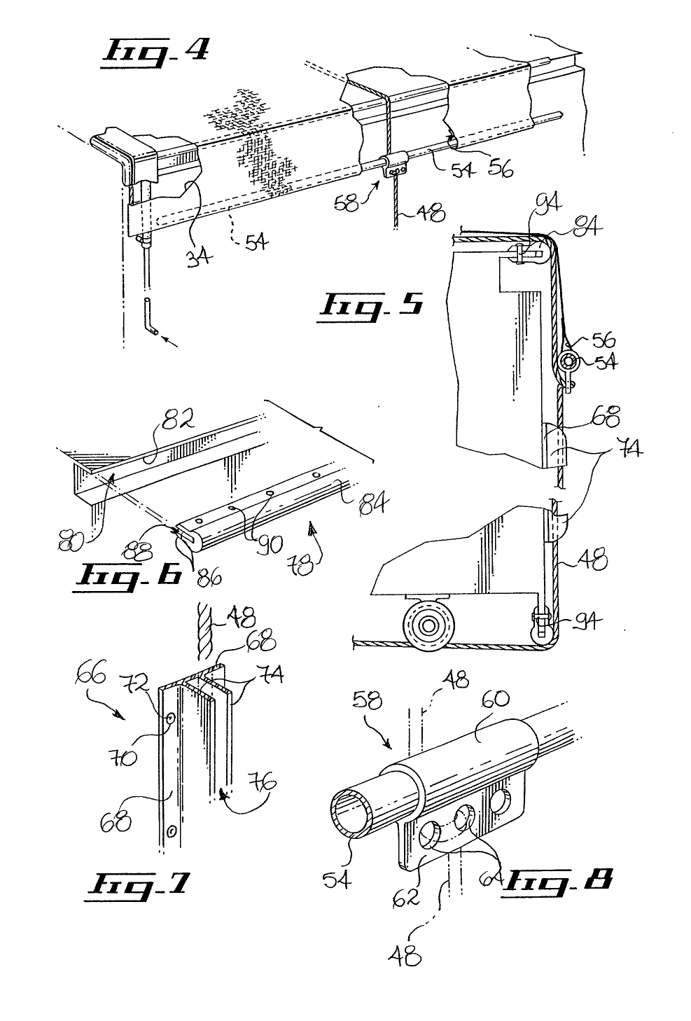

As shown in greater detail in FIG. 6, each friction-reducing component 78 typically includes a cable contacting section 84 having generally rounded contours and a generally disc-shaped cross-sectional configuration. The cable contacting section 84 is typically made out of a material having a generally low friction coefficient such as polytetrafluoroethylene conventionally known as TEFLON™ or the like so as to reduce friction and thus wear on the membrane 34.

Each friction-reducing component 78 is preferably further with a pair of attachment legs 86 extending from the membrane contacting section 84 and defining a mounting spacing 88 therebetween. The mounting spacing 88 is configured and size for substantially fittingly receiving the mounting lip 82. The mounting legs 86 are provided with leg apertures 90 extending therethrough for receiving conventional fastening components 94 such as rivets, bolts, or the like.

The fastening components 94 are adapted to extend through the attachment lip 82 for securing the friction-reducing component 78 to the vehicle 14.

As illustrated more specifically in FIGS. 1 and 9 through 11, the friction reducing means optionally further includes a friction-reducing rod 92 generally centrally mounted on the vehicle top surface 12 and extending longitudinally therealong. In situations wherein the membrane 34 is used over an open top container, the friction-reducing rod 92 not only reduces the friction between the membrane 34 and the vehicle 14 but also helps to support the weight of the membrane 34 over the opening of the open top container. In such situations, the friction-reducing rod 92 is secured to the opposed top surface first and second end peripheral in a conventional manner.

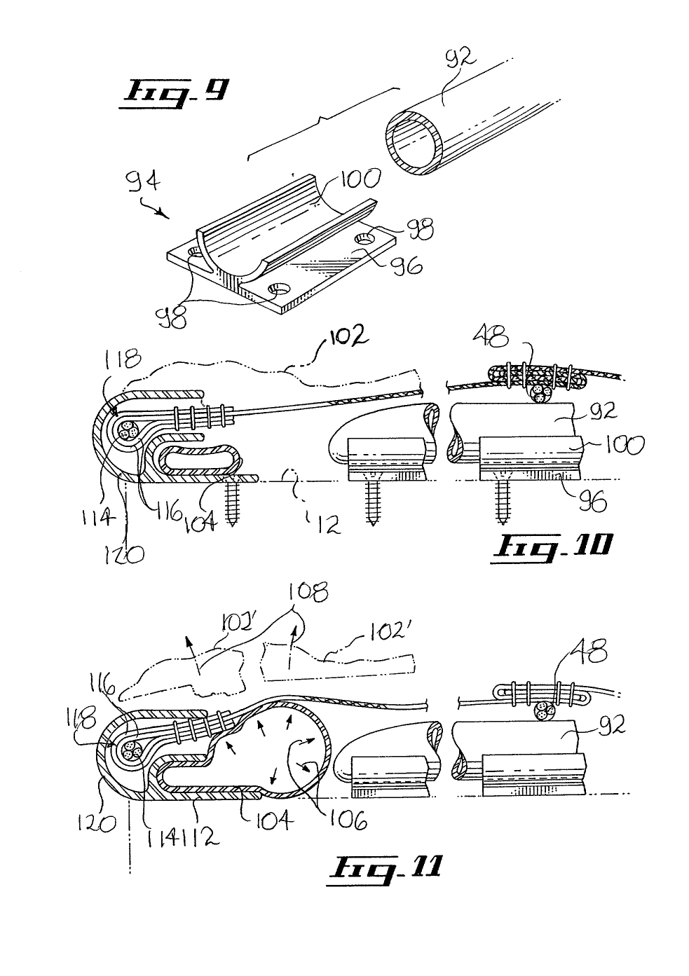

In situations wherein the membrane 34 is used over a closed-top container, the friction-reducing rod 92 is preferably rotatively supported within a supporting rod nestling structure including a set of supporting rod abutment components 94, which is shown in greater detail in FIG. 9. Each supporting rod abutment component 94 preferably include a base plate 96 for securing the supporting rod abutment component to the vehicle top surface 14 using conventional fastening means such as bolts or the like extending through corresponding fixing apertures 98.

Each supporting rod abutment component 94 further include a generally arcuate supporting cradle 100 typically having a generally U-shaped cross-sectional configuration and attached to the base plate 96. The supporting cradle 100 is configured and sized for substantially fittingly receiving the friction-reducing rod 92 and allowing rotation thereof along its longitudinal axis.

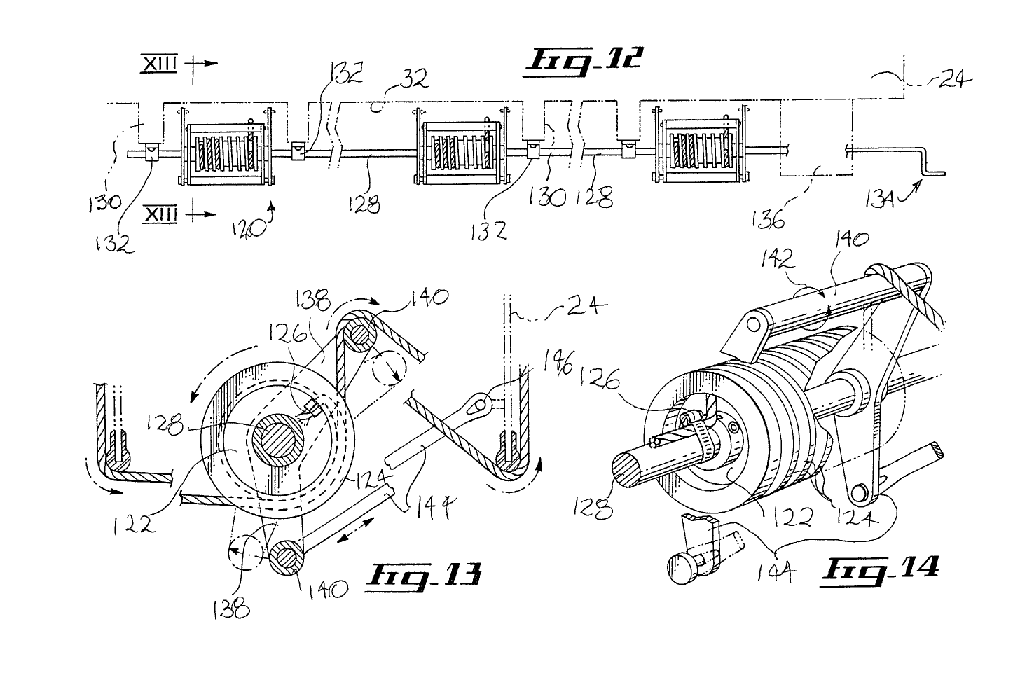

As shown in FIGS. 10 and 11, the longitudinal ends of the friction-reducing rod 92 are preferably given a generally convex and rounded configuration so as to reduce the risks of tearing the membrane 34.

Referring now more specifically to FIGS. 10 and 11, there is shown a first embodiment of a binding snow breaking means mounted on the vehicle 14 for locally breaking slabs of binding snow that may form between the membrane first and second peripheral edges 44, 46 and adjacent structures part of the vehicle 14. In FIGS. 10 and 11, a slab typically made of snow or a mixture of snow and ice is schematically shown in phantom lines and designated by the reference 102. The slab 102 may potentially bind the membrane first and second peripheral edges 44, 46 and adjacent structures part of the vehicle 14 together thus preventing the movement of the membrane 34.

The binding snow breaking means typically includes an inflatable bladder 104 secured to the vehicle 14 by a bladder securing means. As shown in FIG. 11, the bladder 104 is adapted to be inflated by suitable pneumatic means so that a section thereof may create a pressurize abutment contact with the under surface of the membrane 34 in order to deform the latter so as to break the slab 102 into pieces of slab 102′. In FIG. 11, the pneumatic pressure inside the bladder 104 is schematically illustrated by arrows 106, while the movement of pieces of slabs 102 breaking away from the membrane 34 is schematically illustrated by arrows 108. The bladder type component 104 is preferably pneumatically coupled to an air duct 110 extending along at least one of the vehicle side walls 24. Each air duct is preferably suitably pneumatically coupled to a suitable source of pressurized air such as an air compressor for inflating the bladder 104.

Preferably, the bladder-type component 104 is at least partially mounted within a generally “J”-shaped bladder channel 112 mounted on the vehicle top surface 12. The generally “J”-shaped cross-sectional configuration of the bladder channel 112 allows the bladder 104 to protrude therefrom and to contact the membrane 34 when in its inflated configuration.

Either the bladder channel 112 or adjacent components are preferably given a generally aerodynamical configuration to as to reduce drag forces on the vehicle 14 that may result from the installation of the membrane 34. Preferably, the first and second membrane end peripheral edges 44, 46 are provided with a membrane end cable 114 inserted within a cable sleeve 116 formed by membrane segments.

The combination of the membrane end cable 114 and the cable sleeve 116 forms a membrane protuberance 118. Each membrane protuberance 118 is preferably slideably inserted within a protuberance guiding channel 120. Typically, the protuberance guiding channel 120 extends integrally from the bladder channel 112 and both channels 112, 120 form a generally aerodynamical configuration. The aerodynamical configuration of the channels 120, 112 not only reduce the drag forces on vehicle 14 but also reduces the risk of having wind or air pressure created by the displacement of vehicle 14 inserted between the membrane 34 and the vehicle top surface 12 may which potentially cause the membrane 34 to be blown away.

Referring now more specifically to FIGS. 12 through 14, there is shown in greater detail some of the components of the moving means. As mentioned previously, the moving means include a winding device mounted on vehicle 14 for winding the moving cables 48. Typically, according to one embodiment of the invention, the winding device includes a pair of winding mechanisms 120, only one of which is shown in FIG. 12, positioned adjacent each side of the vehicle 14 for each cable 48.

Each winding mechanism 120 typically includes a winding drum 122 preferably having a helicoidal guiding protrusion 124 extending radially therefrom. Each winding drum 120 is adapted to allow winding and unwinding of a given cable 48 while the guiding protrusion 122 insures a tangle-free coiling and uncoiling of the cable 48. The distal ends of the cable 48 are adapted to be attached to the winding drum 122 using conventional cable-to-drum attachment components 126.

The winding drums 122 on each side of the vehicle 14 are preferably mounted about a common winding axle 128. The winding axle 128 is, in turn, rotatively supported and attached to two corresponding attachment protrusion 130 extending from the vehicle bottom wall 32 by corresponding axle supporting sleeves 132.

Typically, a driving means is mechanically coupled to the winding axle 128 for rotating the latter. In the embodiment shown in FIG. 12, the driving means include a manual-type crank 134. Optionally, the driving means may include automated and/or mechanical means such as a conventional motor schematically indicated by a box shown in phantom lines and designated by the reference number 136 in FIG. 12.

Preferably, the moving means further includes a range limiting means mounted on the vehicle 14 for limiting the range of movement of the moving membrane 34 relative to the vehicle 12. Also, preferably, the moving means is still further provided with a cable tightening means mounted on the vehicle 14 for maintaining the moving cables 48 in a generally tightened or taut state.

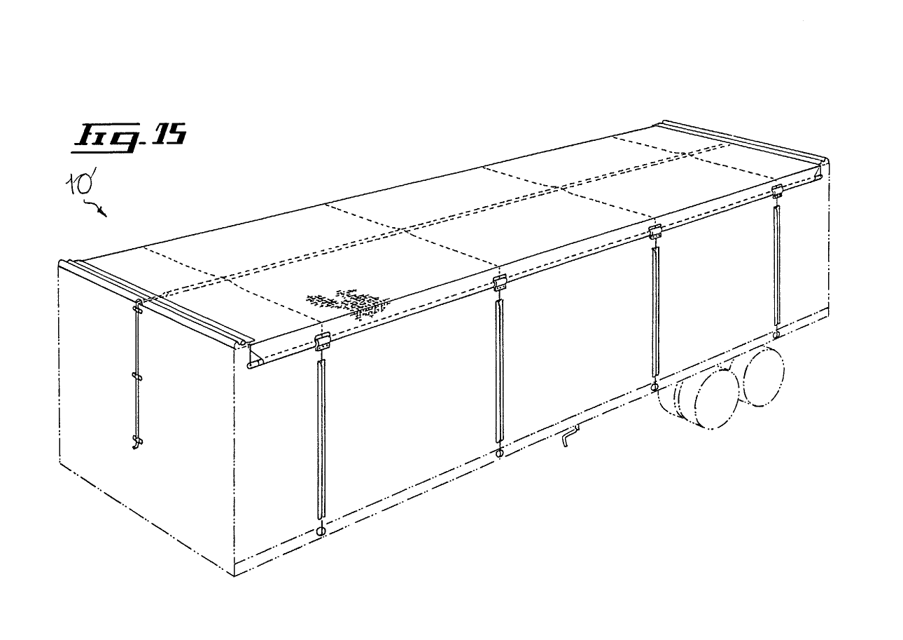

As shown in FIGS. 13 and 14, both the range limiting means and the cable tightening means are combined together in the first embodiment of the invention in the form of generally V-shaped wings 138 pivotally mounted on the winding axle 128. The wings 138 are grouped in pairs so that each pair of wings rotatably supports a cable roller 140 as indicated by arrow 142. Each cable 48 is positioned so as to be at least partially wound around a corresponding roller 140. Anchoring rods 144 are attached at a first end thereof to one of the wings 138 and at an opposed end thereof to an anchoring hook 146 extending from an inner surface of the first and second vehicle side walls 24, 26.

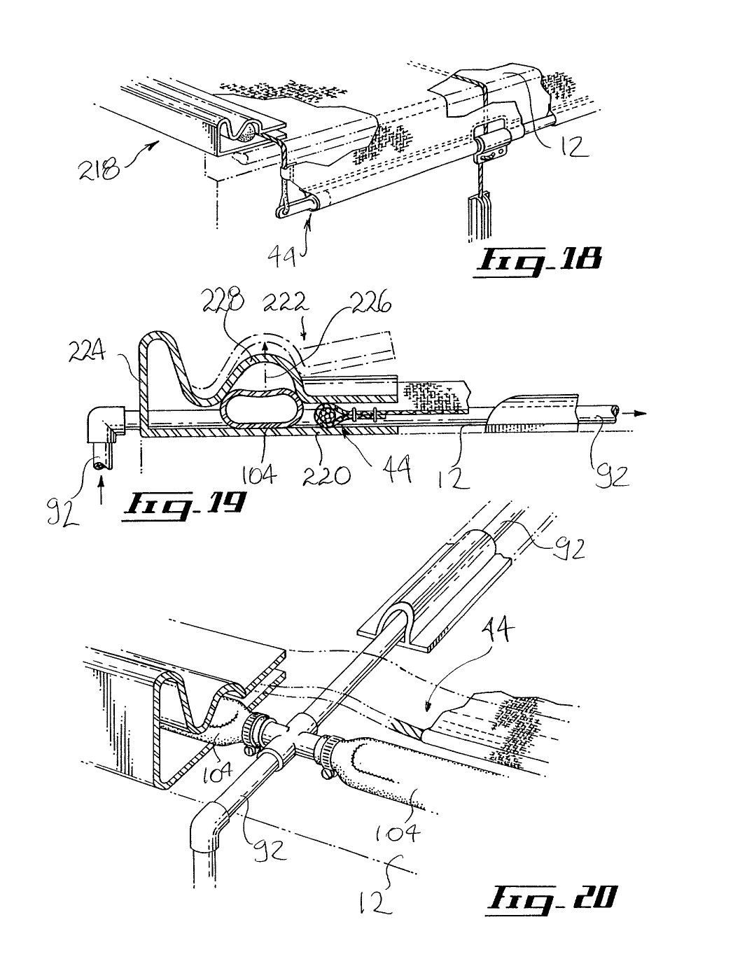

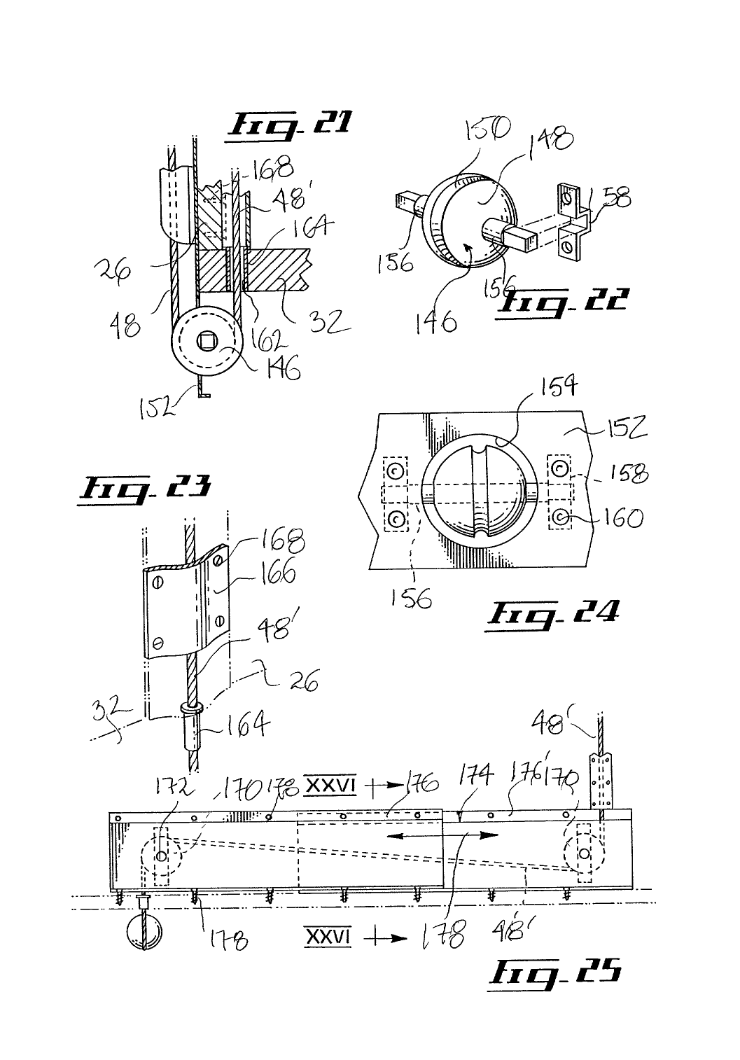

Referring now more specifically to FIGS. 15 through 30, there is shown a device 10′ in accordance with a second embodiment of the present invention. The device 10′ is substantially similar to the device 10 shown in FIGS. 1 through 14, and, hence, similar reference numerals will be used to denote similar components.

One of the main differences between the devices 10 and 10′ reside in the configuration of the moving cables 48. As shown FIGS. 2, 3 and 16, 17, while the moving cables 48 of the first embodiment are positioned exclusively outside of the vehicle 14 the cable 48 of the second embodiment are positioned as to extend partially inside and partially outside of the vehicle 14. In some situations, the second embodiment may prove to be more easily retro-fittable to existing vehicles. Indeed, since some vehicles such as truck trailers are often provided with protruding components such as reflectors, compressors, spare tires, and the like, it may prove difficult to retrofit a membrane such as membrane 34 using the cable arrangement shown in FIGS. 2 and 3.

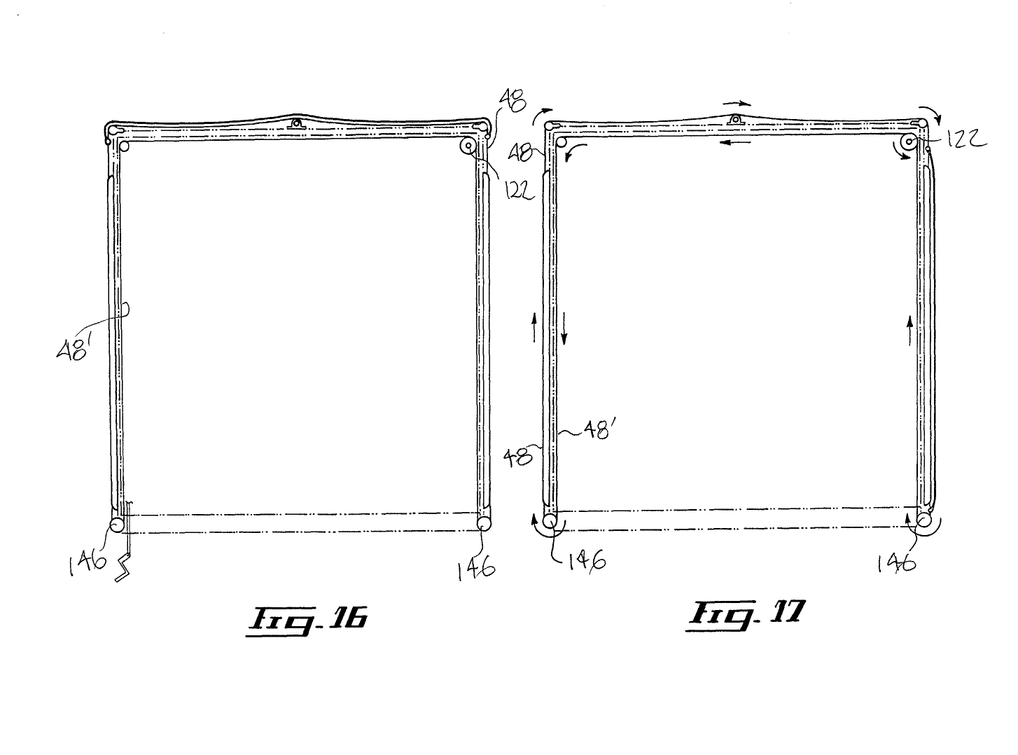

With the embodiment shown in FIGS. 16 and 17, each cable 48 is redirected by main pulleys 146 towards the interior of the vehicle 14 thus avoiding cable interference with components located underneath vehicle 14. The main pulleys 146 are typically located adjacent the intersection between the vehicle bottom wall 32 and one of the vehicle side walls 24, 26.

As shown more specifically in FIGS. 21 through 24, each main pulley 146 is preferably provided with a generally spherical body 148 having an angular recess 150 formed therein for receiving the cable 48. The main pulley 146 is typically mounted to a protruding segment 152 of the side wall 26 extending downwardly from the vehicle bottom wall 32.

Typically, the protruding segment 152 is provided with a pulley recess 154 extending therethrough for substantially nestingly receiving the main pulley 146. A pair of pulley axles 156 extends laterally from the main pulley 146. The main pulley axles 156 are adapted to be supported by axle mounting brackets 158 attached to the protruding segment 152 using conventional fastening means such as rivets, bolts or the like 160. Each main pulley 146 is rotatably mounted on the pulley axles 156 thus allowing movement of a corresponding cable 48.

The cable 48 is redirected by the main pulley 146 from a direction extending substantially parallel to the exterior surface of the first and second vehicle side walls 24, 26 to a position extending in a direction generally parallel to the interior surface of the first and second vehicle side walls 24, 26. In FIG. 21, the interiorly extending segment is designated by the reference numeral 48′.

The cable 48′ penetrates in the interior of the vehicle 14 through a cable channel 162 formed in the vehicle bottom wall 32 and preferably lined with a cable channel sleeve 164. Inside the vehicle 14, the cable 48′ preferably extends through a cable inner sleeve 166 typically having a generally C-shaped cross-sectional configuration and attached to the inner surface of the vehicle first and second side wall 24, 26 using conventional fastening means such as screws 168.

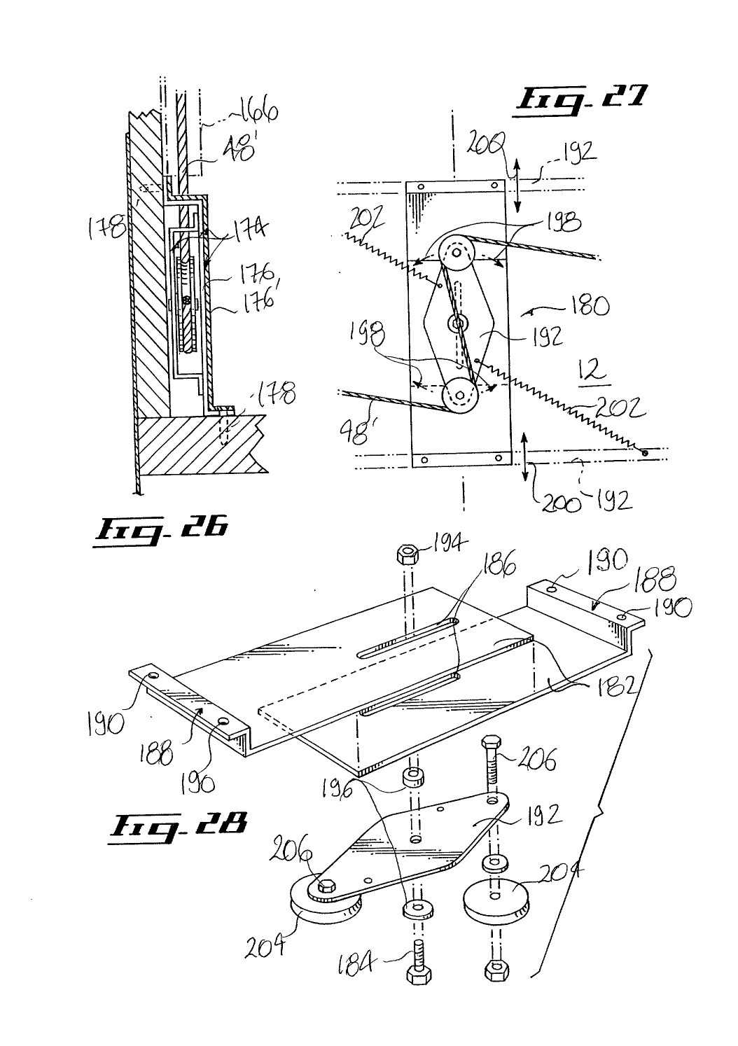

Another main difference between the devices 10 and 10′ respectively associated with first and second embodiment of the present invention resides in the presence of an inner cable redirecting structure 170 shown in FIGS. 25 and 26 for redirecting the inner segment 48′ of the pulling cables in situations wherein at least one of the cable 40′ may interfere with internally located structures within the vehicle 14. For example, in situations wherein the vehicle 14 includes a rear door mounted on tracks it may prove desirable to displace the inner segment of the cable 40′ longitudinally towards the front of the vehicle in order to clear the door tracks while leaving the exterior segment 48 of the cable in its original location so as to evenly distributed the pulling forces on the membrane 34.

In situations wherein the inner segment of the cable 48′ needs to be redirected inner segment redirecting pulleys 170 may be used. The inner segment redirecting pulleys 170 are typically rotatively mounted by corresponding axles 172 to a redirecting pulley casing 174. The redirecting pulley casing 174 is preferably provided with length adjustment means so as to allow customisation of the spacing between inner segment redirecting pulleys 170.

Typically, as shown in FIG. 25, the redirecting pulley casement 174 is of the telescopic-type including segments 176 and 176′ that can be slideably inserted in a telescopic manner within each other as indicated by arrow 178 so as to vary the distance between the inner segment redirecting pulleys 170. The segments 176, 176′ once telescopically adjusted relative to each other may be secured to the vehicle bottom and side walls 32 and 24, 26 using conventional means such as screws 178.

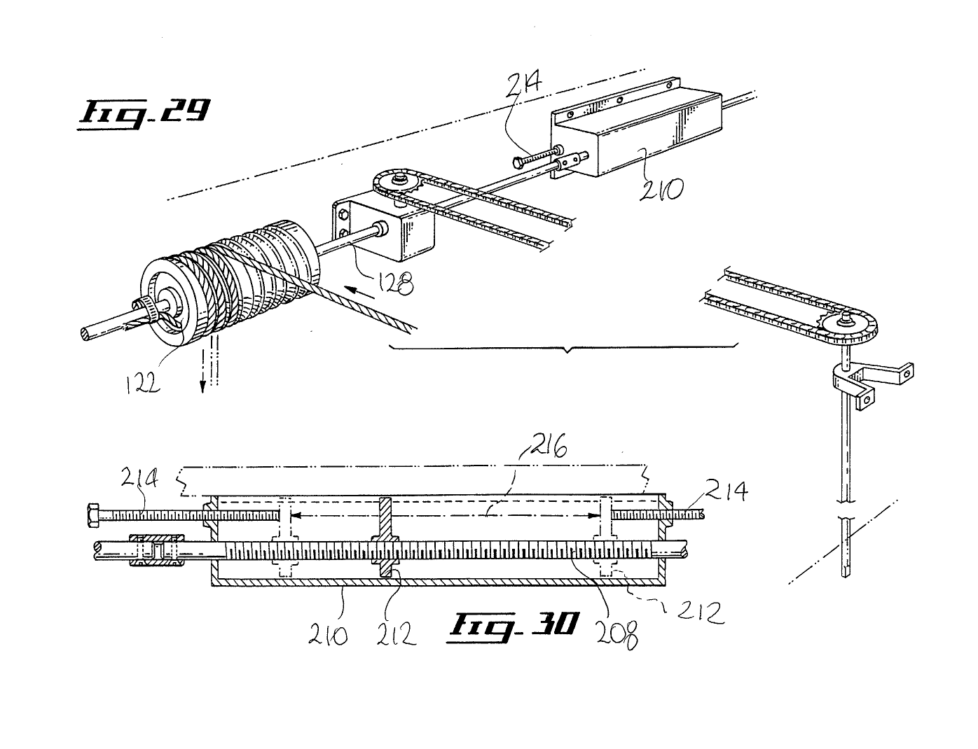

As illustrated more specifically in FIGS. 27 and 28, another main difference between the devices 10 and 10′ respectively associated with first and second embodiments of the present invention resides in the design of the cable tightening mechanism. Referring to FIGS. 27 and 28, there is shown a cable tightening means in accordance with a second embodiment of the present invention. Since the segment 48′ of the cable runs inside the vehicle 14, the cable tightening mechanism is preferably positioned inside the vehicle 14 typically attached to the inner surface of the vehicle top surface 12.

Typically, the cable tightening means of the second embodiment includes a tightening mechanism mounting component 180 attached to the inner surface of the vehicle top surface 12. Preferably, the tightening mechanism attachment component 180 includes a pair of attachment plates 182 slideably attached to each other by a mounting bolt 184 extending through adjustment slots 186.

Each mounting plate 182 is provided with a generally L-shaped shoulder 188 having mounting apertures 190 extending therethrough for attachment to the transversal reinforcement ribs 192 supporting the vehicle top surface 12. A tightening plate 192 is pivotally attached to the mounting plates 182 using a bolt 184, a nut 194 and a set of washers 196. The tightening plate 192 is pivotally mounted so as to rotate about the bolt 184 according to arrows 198 in FIG. 27.

The mounting plates 182 being telescopically attached to each other are adapted to be adjusted relative to each other so as to customize the length of the attachment component to the spacing between the reinforcement ribs 192 as indicated by arrows 200 in FIG. 27. At least one and preferably two biasing components such as helicoidal-type springs 202 are attached between the reinforcement ribs 192 and the tightening plate 192.

The tightening plate 192 is provided with a pair of tightening pulleys 204 rotatively attached at distal ends thereof by suitable fastening means such as a nut, washer and bolt arrangement 206. A segment of the cable 48′ is at least partially wound in opposite directions around opposite tightening pulleys 204. The helicoidal-type springs 202 are adapted to provide a biasing force for rotating the tightening plate 192 in order to maintain the cable 48′ in a substantially taut state.

Yet another difference between the device 10 and 10′ reside in the design of the range limiting means for limiting the range of movement for the moving membrane 34 relative to the vehicle 14. FIGS. 29 and 30 illustrate a range limiting means associated with the second embodiment 10′ of the present invention. With the device 10′, the winding drums 122 and the associated winding rod 128 is adapted to be positioned inside the vehicle 14 typically adjacent an intersection between a side wall 24, 26 and the top wall 12 as illustrated in FIGS. 16 and 17.

The range limiting means includes a range limiting threaded segment 208 formed on a segment of the winding rod 128 preferably enclosed within a protective casing 210. The range limiting means further includes a range limiting cursor 212 threadably mounted on the threaded segment 208. Adjustable abutment stems 214 are threadably mounted through the side walls of the protective casing 210 so as to allow adjustment of the spacing therebetween. Rotation of the winding rod 128 is adapted to be limited by the movement of the cursor 212 indicated by arrow 216 in FIG. 30.

The movement of the cursor 212 is limited by the abutment contact with the distal tip of the adjustment stems 214. By varying the length of the segment of the stems 214 inserted within the protective casing 210, the range of movement of the range limiting cursor 112 and, hence, the range of movement of the protective membrane 34 is limited.

Still another difference between the devices 10 and 10′ resides in the configuration of the binding snow breaking means. FIGS. 18 through 20 illustrate the configuration of the binding snow breaking means associated with the second embodiment of the present invention. The binding snow breaking means includes an end sleeve 218 defining an end sleeve base segment 220 having a generally flat configuration and adapted to be mounted on the vehicle top surface 12.

The end sleeve 218 also defines an end sleeve pivotable segment 222 hingedly connected to the end sleeve base segment 220 by an end sleeve hinge segment 224. The end sleeve hinge segment 224 allows pivotal movement of the end sleeve pivotable segment 222 relative to the end sleeve base segment 220 according to arrow 226 in FIG. 19. Typically, the end sleeve 218 is made out of suitable polymeric resin having inherent resilient characteristics for creating an inherent biasing force biasing the end sleeve pivotable segment 222 towards its initial configuration shown in full lines in FIG. 19.

The end sleeve component 218 is configured so as to slideably receive the membrane first or second end peripheral edge 44, 46 and so that the end sleeve pivotable segment 222 overlaps the latter. The end sleeve pivotable segment 222 preferably defines an end sleeve protrusion 228 configured and sized for receiving the bladder type component 104.

As illustrated in FIG. 19, inflation of the bladder type component 104 causes the end sleeve pivotable segment 222 to pivot to its pivoted configuration shown in phantom lines in FIG. 19. The pivotable movement of the end sleeve pivotable segment 222 is adapted to break snow that may have bound to the membrane first and second end peripheral edges 44, 46.

Deflation of the bladder type component 104 allows the inherent biasing force in the end sleeve component 218 to resiliently spring back the end sleeve pivotable segment 222 towards its initial configuration shown in full lines in FIG. 19. Pressurized air for inflating the bladder type component 104 is preferably provided through the air ducts 92 preferably extending substantially centrally and longitudinally along the vehicle top surface 12.

The present invention also relates to a method for preventing snow falling towards the vehicle top surface from accumulating on the latter. The method comprises the step of first mounting a membrane to the vehicle in a protecting configuration wherein the membrane generally protectively overlies the vehicle top surface so as to enable the membrane to collect a certain amount of the snow falling towards the vehicle top surface.

Once a certain amount of snow has accumulated on the membrane, the method involves the step of moving the membrane while the latter is still mounted on the vehicle from the protective configuration to a retracted configuration wherein the membrane is at least partially retracted from the vehicle top surface and tilted at an angle allowing the discharge away from the vehicle of the snow having been collected by the membrane when the latter was in the protecting configuration.

Preferably, the method involves mounting the membrane to the vehicle so that the membrane lies in a generally parallel relationship relative to one of the vehicle sidewalls when the membrane is in the retracted configuration. Also, preferably, the membrane is maintained in a generally taut state when in both the covering and retracted configurations and also during movement between the covering and retracted configurations.

Furthermore, preferably, the membrane slideably contacts one of the top surface peripheral edges as it moves between the protecting and retracted configurations. The contact with one of the top surface peripheral edges allows the membrane to be bent at a membrane angle allowing for the dislodgement of snow that may have accumulated on the membrane and may have adhered to the latter. In other words, as the membrane moves from its protecting to its retracted configuration it slides along one of the top surface peripheral edges and the contact with the top surface peripheral edge bends the membrane and breaks slabs of ice or snow that may have adhered to the membrane.

The embodiments of the invention in which an exclusive privilege or property is claimed are defined as follows:

1. A device for protecting a vehicle top surface part of a vehicle and for removing snow from said vehicle top surface, said vehicle top surface defining a top surface first side peripheral edge, an opposed top surface second side peripheral edge, a top surface first end peripheral edge and an opposed top surface second end peripheral edge, said vehicle defining a vehicle first side wall extending from said top surface first side peripheral edge and a vehicle second side wall extending from said top surface second side peripheral edge, said vehicle also defining a vehicle first end wall extending from said top surface first end peripheral edge and a vehicle second end wall extending from said top surface second end peripheral edge, said vehicle further defining a vehicle bottom wall, said device comprising:
a generally flexible membrane, said membrane being configured and sized so as to substantially cover said vehicle top surface when said membrane is in a covering configuration substantially overlying said vehicle top surface;
a mounting means attached to both said vehicle and said membrane for mounting said membrane to said vehicle, said mounting means allowing said membrane to slidably move between said covering configuration and a retracted configuration wherein said membrane is at least partially removed from said vehicle top surface and said membrane is at least partially in an overlying relationship relative to said vehicle first side wall.

2. A device as recited in claim 1 wherein said membrane is mounted on said vehicle by said mounting means so as to be in a substantially taut state when in both said covering and retracted configurations.

3. A device as recited in claim 2 wherein said membrane is mounted on said vehicle so as to remain in a generally taut state as it is moved between said covering and retracted configurations, said membrane being bent according to a membrane bending angle as it moves between said covering and retracted configurations.

4. A device as recited in claim 3 further comprising a moving means for moving said membrane between said covering and retracted configurations.

5. A device as recited in claim 4 wherein
said membrane defines a membrane first side peripheral edge, a membrane second side peripheral edge, a membrane first end peripheral edge and a membrane second end peripheral edge;
said moving means including
a moving cable, said moving cable defining a cable first end and a cable second end, said cable first end being attached to said membrane first side peripheral edge and said cable second end being attached to said membrane second side peripheral edge;
a winding device mounted on said vehicle for winding said moving cable so that selective winding and unwinding of said moving cable on and from said winding device allows for the movement of said membrane between said covering and retracted configurations.

6. A device as recited in claim 5 wherein said moving means includes a cable guiding means mounted on said vehicle for guiding the slidable movement of said moving cable relative to said vehicle.

7. A device as recited in claim 5 wherein said moving means includes a friction reducing means mounted on said vehicle for reducing the frictional force created by the slidable movement of said moving membrane relative to said vehicle when said moving membrane is moved between said covering and retracted configurations.

8. A device as recited in claim 5 wherein said moving means includes a range limiting means mounted on said vehicle for limiting the range of movement of said moving membrane relative to said vehicle.

9. A device as recited in claim 5 wherein said moving means includes a cable tightening means mounted on said vehicle for maintaining said moving cable in a generally tightened state.

10. A device as recited in claim 5 further comprising a binding snow breaking means mounted on said vehicle for locally breaking slabs of binding snow that may form between said membrane first and second end peripheral edges and adjacent structures part of said vehicle binding said membrane first and second end peripheral edges and adjacent structures part of said vehicle together and preventing the movement of said moving membrane.

11. A device as recited in claim 10 wherein said binding snow breaking means has a generally aerodynamical configuration.

12. A method for preventing snow falling towards a vehicle top surface part of a vehicle from accumulating on said vehicle top surface, said vehicle top surface defining pair of top surface side peripheral edges, said vehicle defining a pair of vehicle side walls extending from said vehicle top surface, said method comprising the steps of:
mounting a membrane to said vehicle in a protecting configuration wherein said membrane generally protectively overlies said vehicle top surface so as to enable said membrane to collect a certain amount of said snow falling towards said vehicle top surface;
once a certain amount of snow has accumulated on said membrane, moving said membrane while the latter is still mounted on said vehicle from a protecting configuration to a retracted configuration wherein said membrane is at least partially retracted from said vehicle top surface and tilted at an angle allowing the discharge away from said vehicle of said certain amount of said snow having been collected by said membrane when the latter was in said protecting configuration.

13. A method as recited in claim 12 wherein said membrane lies in a generally parallel relationship relative to one of said vehicle side walls when said membrane is in said retracted configuration.

14. A method as recited in claim 12 further comprising the steps of maintaining said membrane in a generally taut state when in both said covering and retracted configurations.

15. A method as recited in claim 13 wherein said membrane slidably contacts one of said top surface second side peripheral edges as it moves between said protecting and retracted configurations, the contact with one of said top surface second side peripheral edges allowing said membrane to be bent at a membrane angle allowing for the dislodgment from said membrane of snow accumulation that may have adhered to said membrane.

16. A device for protecting a vehicle top surface part of a vehicle and for removing snow from said vehicle top surface, said vehicle top surface defining a top surface first side peripheral edge, an opposed top surface second side peripheral edge, a top surface first end peripheral edge and an opposed top surface second end peripheral edge, said vehicle defining a vehicle first side wall extending from said top surface first side peripheral edge and a vehicle second side wall extending from said top surface second side peripheral edge, said vehicle also defining a vehicle first end wall extending from said top surface first end peripheral edge and a vehicle second end wall extending from said top surface second end peripheral edge, said vehicle further defining a vehicle bottom wall, said device comprising:
a generally flexible membrane, said membrane being configured and sized so as to substantially cover said vehicle top surface when said membrane is in a covering configuration substantially overlying said vehicle top surface;
a mounting mechanism attached to both said vehicle and said membrane for mounting said membrane to said vehicle, said mounting mechanism allowing said membrane to slidably move between said covering configuration and a retracted configuration wherein said membrane is at least partially removed from said vehicle top surface and said membrane is at least partially in an overlying relationship relative to said vehicle first side wall; said mounting mechanism allowing said membrane to be in a substantially taut state when in both said covering and retracted configurations and to remain in a generally taut state as it is moved between said covering and retracted configurations.

17. A device as recited in claim 16 wherein said mounting mechanism allows said membrane to slidably contacts one of said top surface second side peripheral edges as it moves between said protecting and retracted configurations, the contact with one of said top surface second side peripheral edges allowing said membrane to be bent at a membrane angle allowing for the dislodgment from said membrane of snow accumulation that may have adhered to said membrane.

18. A device as recited in claim 17 further comprising a moving mechanism for moving said membrane between said covering and retracted configurations; said membrane defining a membrane first side peripheral edge, a membrane second side peripheral edge, a membrane first end peripheral edge and a membrane second end peripheral edge;
said moving mechanism including a moving cable, said moving cable defining a cable first end and a cable second end, said cable first end being attached to said membrane first side peripheral edge and said cable second end being attached to said membrane second side peripheral edge; said moving mechanism also including a winding device mounted on said vehicle for winding said moving cable so that selective winding and unwinding of said moving cable on and from said winding device allows for the movement of said membrane between said covering and retracted configurations.

19. A device as recited in claim 18 wherein said moving mechanism includes a cable tightening mechanism mounted on said vehicle for maintaining said moving cable in a generally tightened state.

20. A device as recited in claim 5 further comprising a binding snow breaking mechanism mounted on said vehicle for locally breaking slabs of binding snow that may form between said membrane first and second end peripheral edges and adjacent structures part of said vehicle binding said membrane first and second end peripheral edges and adjacent structures part of said vehicle together and preventing the movement of said moving membrane.
